(19) United States
(12) Patent Application Publication
(10) Pub. No.: US 2023/0388701 A1
(43) Pub. Date: Nov. 30, 2023

(54) Electroacoustic Transducer

(71) Applicant: Bose Corporation, Framingham, MA (US)

(72) Inventors: Ryan C. Struzik, Hopkinton, MA (US); Mark A. Hayner, Belmont, MA (US)

(73) Assignee: Bose Corporation, Framingham, MA (US)

(21) Appl. No.: 18/031,827

(22) PCT Filed: Oct. 14, 2021
(86) PCT No.: PCT/US21/54899

§ 371 Date: Apr. 13, 2023

Related U.S. Application Data
(60) Provisional application No. 63/091,677, filed on Oct. 14, 2020.

(51) Int. Cl. H04R 1/22; H04R 9/02; H04R 9/04; H04R 7/12; H04R 1/02; H04R 9/06

(52) U.S. Cl. CPC H04R 1/227; H04R 9/025; H04R 9/046; H04R 7/12; H04R 1/025; H04R 9/045; H04R 9/063; H04R 2209/026

(57) ABSTRACT

An electroacoustic transducer includes a first diaphragm, a first voice coil that is coupled to the first diaphragm, a second diaphragm, a second voice coil that is coupled to the second diaphragm, and a single common magnetic circuit that is configured to provide a magnetic field in both a first magnetic circuit gap and a separate second magnetic circuit gap. The first voice coil is located at least in part in the first magnetic circuit gap and the second voice coil is located at least in part in the second magnetic circuit gap.

### CROSS-REFERENCE TO RELATED APPLICATION

This application claims priority of Provisional Application 63/091,677, filed on Oct. 14, 2020, the entire disclosure of which is incorporated herein by reference.

### BACKGROUND

This disclosure relates to an electroacoustic transducer.

Wearable open audio devices are challenged to produce low frequency (bass) output for the user because they do not seal against the ear or ear canal and a small form factor is desired and so the electroacoustic transducer is naturally small and so has minimal volume displacement.

### SUMMARY

All examples and features mentioned below can be combined in any technically possible way.

In one aspect, an electroacoustic transducer includes a first diaphragm, a first voice coil that is coupled to the first diaphragm, a second diaphragm, a second voice coil that is coupled to the second diaphragm, and a single common magnetic circuit that is configured to provide a magnetic field in both a first magnetic circuit gap and a separate second magnetic circuit gap. The first voice coil is located at least in part in the first magnetic circuit gap and the second voice coil is located at least in part in the second magnetic circuit gap.

In some examples the first and second diaphragms are both configured to move back and forth along a common axis. In an example the first and second voice coils are located at different distances from the common axis. In an example the first and second diaphragms are round and both centered on the common axis. In an example the first and second voice coils are annular and are located at different radii from the common axis. In an example the single common magnetic circuit comprises a permanent magnet with an outer extent that is closer to the common axis than are both of the voice coils. In an example the single common magnetic circuit further comprises a generally annular magnet located farther from the common axis than are both of the voice coils. A generally annular magnet can be round or oval or a similar shape (e.g., a racetrack shape) and can be made from a single unitary member or from two or more separate members that are shaped and/or arranged to achieve a generally annular shape. In an example a racetrack shape can be accomplished with several bar magnets aligned along a generally annular path. In an example the permanent magnet and the generally annular magnet are generally co-planar.

In some examples the single common magnetic circuit further comprises ferromagnetic plates on two sides of the permanent magnet, one ferromagnetic plate between the permanent magnet and the first diaphragm and the other ferromagnetic plate between the permanent magnet and the second diaphragm. In an example the single common magnetic circuit further comprises generally annular ferromagnetic plates on two sides of the annular permanent magnet, one generally annular ferromagnetic plate between the generally annular magnet and the first diaphragm and the other generally annular ferromagnetic plate between the generally annular magnet and the second diaphragm. In an example the electroacoustic transducer further includes a non-magnetic or magnetic support between one ferromagnetic plate and one generally annular ferromagnetic plate. In an example one coil is located between the support and the permanent magnet and the other coil is located between the support and the generally annular permanent magnet. In an example one magnetic circuit gap is between a first ferromagnetic plate and a first generally annular ferromagnetic plate and the other magnetic circuit gap is between a second ferromagnetic plate and a second generally annular ferromagnetic plate.

In some examples the single common magnetic circuit further comprises a ferromagnetic plate on a first side of the permanent magnet between the permanent magnet and the first diaphragm, a generally annular ferromagnetic plate on a second side of the annular magnet between the generally annular magnet and the second diaphragm, and a ferromagnetic yoke member comprising a first portion on the second side of the permanent magnet, a second portion on the first side of the generally annular magnet, and a connecting portion located between both coils that connects the first and second portions. In an example the single common magnetic circuit further comprises ferromagnetic plates on two sides of the permanent magnet, a first ferromagnetic plate between the permanent magnet and the first diaphragm and a second ferromagnetic plate between the permanent magnet and the second diaphragm, and a ferromagnetic yoke member located at least in part outside of the first coil, wherein the yoke member comprises a first portion spaced from the first ferromagnetic plate, a second portion spaced from the second ferromagnetic plate, and a connecting portion that connects the first and second portions.

In some examples the first and second diaphragms are configured to move in opposition. In an example the first and second diaphragms are configured to move in parallel. In an example a total mechanical moving mass of the first diaphragm and coil is approximately equal to that of the second diaphragm and coil. In an example the first and second diaphragms are generally rectangular.

In some examples the first and second diaphragms, the first and second coils, and the magnetic circuit are contained in a housing that defines at least one sound-emitting opening. In an example the first and second diaphragms each generate front side acoustic radiation from a front side thereof, and the housing further defines a first front acoustic cavity that is configured to receive the front side acoustic radiation from the first diaphragm and a second front acoustic cavity that is configured to receive the front side acoustic radiation from the second diaphragm. In some examples the housing defines a first sound-emitting opening that is configured to emit sound from the first front acoustic cavity into an external environment and a second sound-emitting opening that is configured to emit sound from the second front acoustic cavity into the external environment. In an example the housing further defines a common rear acoustic cavity that is configured to receive rear side acoustic radiation from both the first and second diaphragms, and a third sound-emitting opening that is configured to emit sound from the rear acoustic cavity into the environment. In an example the housing defines two opposed ends, and the first and second sound-emitting openings are in one end of the housing and the third sound-emitting opening is in the other end of the housing. In an example the housing defines two opposed ends, and the first sound-emitting opening is in one end of the housing and the second sound-emitting opening is in the other end of the housing.

### BRIEF DESCRIPTION OF THE DRAWINGS

FIG. 1 is cross section of an electroacoustic transducer.

FIG. 2 is cross section of an electroacoustic transducer.

FIG. 3 is cross section of an electroacoustic transducer.

FIG. 4A is top view of an electroacoustic transducer and FIG. 4B is a cross-section taken along line 4B-4B.

FIG. 5 is a cross-sectional view of a wearable audio device.

FIG. 6 is a cross-sectional view of a wearable audio device.

### DETAILED DESCRIPTION

This disclosure relates to an electroacoustic transducer and a wearable open audio device that includes the electroacoustic transducer. Wearable open audio devices typically include one or more electro-acoustic transducers (i.e., audio drivers) that are located off of the ear canal opening. Wearable open audio devices are further described in U.S. Pat. No. 10,397,681, the entire disclosure of which is incorporated herein by reference for all purposes.

A wearable open audio device includes but is not limited to an off-ear headphone, i.e., a device that has one or more electro-acoustic transducers that are coupled to the head or ear (typically by a support structure) but do not occlude the ear canal opening. In some examples a wearable open audio device is an off-ear headphone comprising audio eyeglasses, but that is not a limitation of the disclosure as in a wearable open audio device the device is configured to deliver sound to one or both ears of the wearer where there are typically no ear cups and no ear buds. The wearable audio systems contemplated herein may include a variety of devices that include an over-the-ear hook, such as a wireless headset, hearing aid, eyeglasses, a protective hard hat, and other open ear audio devices.

A headphone refers to a device that typically fits around, on, or in an ear and that radiates acoustic energy directly or indirectly into the ear canal. Headphones are sometimes referred to as earphones, earpieces, headsets, earbuds, or sport headphones, and can be wired or wireless. A headphone includes a driver to transduce electrical audio signals to acoustic energy. The driver may or may not be housed in an earcup or in a housing that is configured to be located on the head or on the ear, or to be inserted directly into the user's ear canal. A headphone may be a single stand-alone unit or one of a pair of headphones (each including at least one acoustic driver), one for each ear. A headphone may be connected mechanically to another headphone, for example by a headband and/or by leads that conduct audio signals to an acoustic driver in the headphone. A headphone may include components for wirelessly receiving audio signals.

It should be noted that although specific implementations of wearable open audio devices primarily serving the purpose of acoustically outputting audio are presented with some degree of detail, such presentations of specific implementations are intended to facilitate understanding through provisions of examples and should not be taken as limiting either the scope of the disclosure or the scope of the claim coverage.

Wearable open audio devices are challenged to produce low frequency (bass) output for the user because they do not seal against the ear or ear canal and a small form factor is desired. Accordingly the electroacoustic transducer is naturally small and so has minimal volume displacement. Bass output can generally be improved by increasing the maximum volume displacement that the driver can produce, either by using a larger driver or using multiple drivers. However, increasing the size of the acoustics can impact the industrial design. Therefore, a driver that can produce a lot of volume displacement relative to its total size/volume is desirable in a wearable open audio device. Furthermore, wearable open audio devices with hearing assistance and/or active noise reduction (ANR) use microphones to pick up environment sounds, but the microphones should not pick up driver playback sounds. However, motion of the driver can also induce vibrations in the device housing, which the microphones can pick up, contributing to undesirable feedback instability. Using two drivers, facing opposite directions and driven in-phase, can balance the force imparted to the product and reduce vibration, as well as provide increased output from the additional driver. However, two drivers double the volume of the acoustics. A more space-efficient means of packaging two opposed drivers is thus desirable.

The disclosure includes a driver design that incorporates two opposed diaphragms with different size voice coils and a shared magnetic circuit between the diaphragms. In an example there is a center magnet with top and bottom steel, oppositely poled outer magnet(s) with top and bottom steel, and a non-magnetic piece or yoke connecting them between the coils. The two voice coil lead outs may be wired together so that the diaphragms move in either opposition or in the same direction when driven by a single source. They may be wired separately so they can be driven by independent sources for an active array application. Audio sources and driver wiring are well known in the field and so are not further described herein.

The outer steel pieces may also extend to form a top or bottom basket, and may have holes to allow venting of the air behind the diaphragms. The top or bottom basket may alternatively be formed by a separate vented frame, which can be but need not be made of plastic. In an example there are no outer magnet(s) and a single steel piece forms the yoke.

The driver may be round, in which case the outer magnet may be a continuous or segmented ring, or be made up of multiple bar magnets. The driver may similarly be oval or racetrack-shaped. The driver may also be rectangular, in which case the outer magnet may be split into two or four separate bar magnets; magnets on only two sides while leaving the other two sides open may improve air flow out from behind the diaphragm to reduce flow noise and distortion.

In examples the driver is used in a near-ear acoustic dipole module, wherein the dual diaphragms are driven so they move in opposite directions (e.g., both in, or both out). The fronts of each diaphragm are in separate front volumes that each have a sound-emitting opening; the two sound-emitting openings are located close together. The diaphragms share a back/center cavity, where their back volume displacement combines and exits through a sound-emitting opening that is located farther from the ear than are the front-side openings. The outputs from the fronts and back/center are out-of-phase to create a dipole-like behavior where sound cancels in the far field so there is less sound spillage that can be heard by others located near the person wearing the open audio device.

In this example the volume displacement from each diaphragm combines to improve the bass output compared to a single diaphragm driver. Therefore, the bass output doubles, but the driver height only increases by an estimated 40%. Also, the motion of the diaphragms is opposed, so the force imposed on the structure is balanced, which reduces vibrations. This can subsequently reduce undesirable feedback instability for products with microphones for hearing assistance and/or ANR.

In another application of a near-ear acoustic dipole module, the dual diaphragms are driven so they move in the same direction (e.g., both up, or both down). The back/center cavity is sealed to protect the coil, lead outs, and motor from the environment. The diaphragms have separate front cavities whereby one exits near the ear and the other exits farther from the ear. The output of the separate fronts is out-of-phase to create a dipole. The acoustic module itself can then be waterproof since the front of the diaphragms can be made waterproof and the backs are sealed.

Other applications of the transducer are possible and are within the scope of the present disclosure.

Benefits of the disclosure include the following. The transducer design can improve bass output in a small size by enabling two diaphragms to share a magnetic circuit and combine their volume displacements. Also, by using two opposed balanced diaphragms the design can reduce vibrations imparted to products; this can subsequently reduce undesirable feedback instability for products with microphones for hearing assistance and/or ANR. Alternatively to increasing bass output, the transducer can be used for waterproof acoustics by sealing the coil and motor internally and only having the fronts of the dual diaphragms exposed to the environment.

In one aspect, an electroacoustic transducer includes a first diaphragm, a first voice coil that is coupled to the first diaphragm, a second diaphragm, a second voice coil that is coupled to the second diaphragm, and a single common magnetic circuit that is configured to provide a magnetic field in both a first magnetic circuit gap and a separate second magnetic circuit gap. The first voice coil is located at least in part in the first magnetic circuit gap and the second voice coil is located at least in part in the second magnetic circuit gap.

In some examples the first and second diaphragms are both configured to move back and forth along a common axis. In an example the first and second voice coils are located at different distances from the common axis. In an example the first and second diaphragms are round and both centered on the common axis. In an example the first and second voice coils are annular and are located at different radii from the common axis. In an example the single common magnetic circuit comprises a permanent magnet with an outer extent that is closer to the common axis than are both of the voice coils. In an example the single common magnetic circuit further comprises a generally annular magnet located farther from the common axis than are both of the voice coils. In an example the permanent magnet and the generally annular magnet are generally co-planar.

In some examples the single common magnetic circuit further comprises ferromagnetic plates on two sides of the permanent magnet, one ferromagnetic plate between the permanent magnet and the first diaphragm and the other ferromagnetic plate between the permanent magnet and the second diaphragm. In an example the single common magnetic circuit further comprises generally annular ferromagnetic plates on two sides of the annular permanent magnet, one generally annular ferromagnetic plate between the generally annular magnet and the first diaphragm and the other generally annular ferromagnetic plate between the generally annular magnet and the second diaphragm. In an example the electroacoustic transducer further includes a magnetic or non-magnetic support between one ferromagnetic plate and one generally annular ferromagnetic plate. In an example one coil is located between this support and the permanent magnet and the other coil is located between this support and the generally annular permanent magnet. In an example one magnetic circuit gap is between a first ferromagnetic plate and a first generally annular ferromagnetic plate and the other magnetic circuit gap is between a second ferromagnetic plate and a second generally annular ferromagnetic plate.

In some examples the single common magnetic circuit further comprises a ferromagnetic plate on a first side of the permanent magnet between the permanent magnet and the first diaphragm, a generally annular ferromagnetic plate on a second side of the annular magnet between the generally annular magnet and the second diaphragm, and a ferromagnetic yoke member comprising a first portion on the second side of the permanent magnet, a second portion on the first side of the generally annular magnet, and a connecting portion located between both coils that connects the first and second portions. In an example the single common magnetic circuit further comprises ferromagnetic plates on two sides of the permanent magnet, a first ferromagnetic plate between the permanent magnet and the first diaphragm and a second ferromagnetic plate between the permanent magnet and the second diaphragm, and a ferromagnetic yoke member located at least in part outside of the first coil, wherein the yoke member comprises a first portion spaced from the first ferromagnetic plate, a second portion spaced from the second ferromagnetic plate, and a connecting portion that connects the first and second portions.

In some examples the first and second diaphragms are configured to move in opposition. In an example a total mechanical moving mass of the first diaphragm and coil is approximately equal to that of the second diaphragm and coil. In an example the first and second diaphragms are generally rectangular. In some examples the first and second diaphragms, the first and second coils, and the magnetic circuit are contained in a housing that defines at least one sound-emitting opening. In an example the first and second diaphragms each generate front side acoustic radiation from a front side thereof, and the housing further defines a first front acoustic cavity that is configured to receive the front side acoustic radiation from the first diaphragm and a second front acoustic cavity that is configured to receive the front side acoustic radiation from the second diaphragm.

In some examples the housing defines a first sound-emitting opening that is configured to emit sound from the first front acoustic cavity into an external environment and a second sound-emitting opening that is configured to emit sound from the second front acoustic cavity into the external environment. In an example the housing further defines a common rear acoustic cavity that is configured to receive rear side acoustic radiation from both the first and second diaphragms, and a third sound-emitting opening that is configured to emit sound from the rear acoustic cavity into the environment. In an example the housing defines two opposed ends, and the first and second sound-emitting openings are in one end of the housing and the third sound-emitting opening is in the other end of the housing. In an example the housing defines two opposed ends, and the first sound-emitting opening is in one end of the housing and the second sound-emitting opening is in the other end of the housing. In an example the first and second diaphragms are configured to move in parallel.

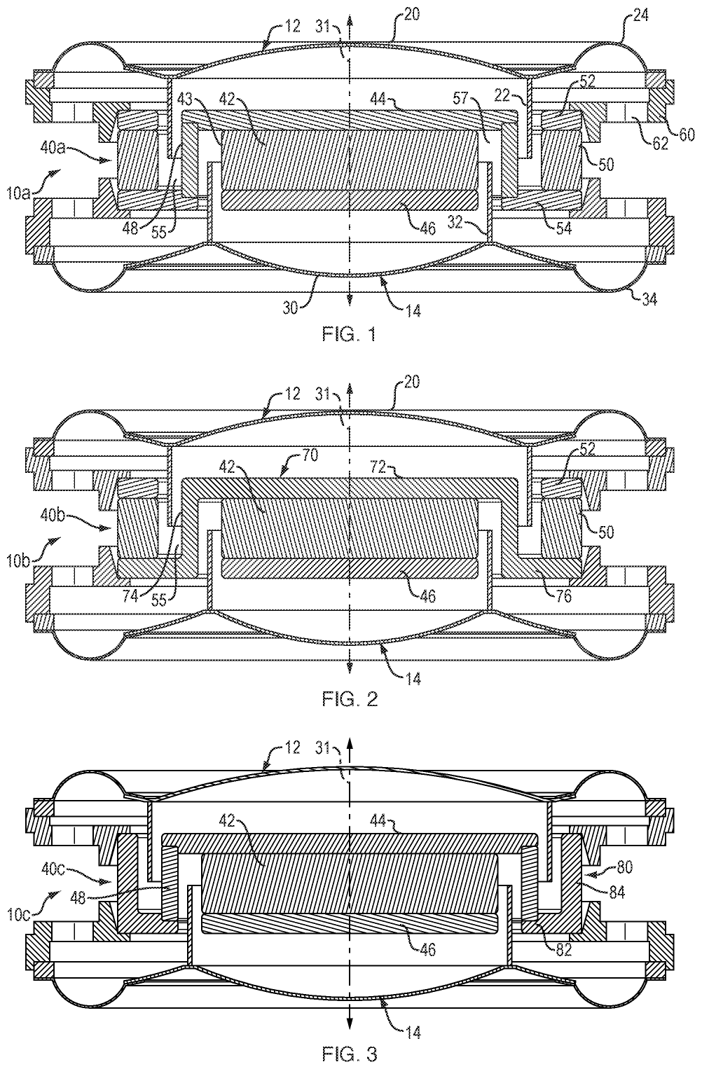

FIG. 1 illustrates electroacoustic transducer 10a that includes a first diaphragm 12 with front radiating surface 20, and a first voice coil 22 that is directly or indirectly coupled to the first diaphragm. Indirect coupling can be accomplished with a bobbin on which the coil is wound. Transducer 10a also includes a second diaphragm 14 with front radiating surface 30, and a second voice coil 32 that is directly or indirectly coupled to the second diaphragm. Indirect coupling can be accomplished with a bobbin on which the coil is wound. Bobbins are known in the technical field and so are not further described herein. Bobbins are not shown in any of the drawings, simply for the sake of clarity of illustration. There is a single common magnetic circuit that is configured to provide a magnetic field in both a first magnetic circuit gap 55 and a separate second magnetic circuit gap 57. The first voice coil 22 (and bobbin when used) is located at least in part in the first magnetic circuit gap 55 and the second voice coil 32 (and bobbin when used) is located at least in part in the second magnetic circuit gap 57. The magnetic circuit gaps can be radially aligned as shown, or not. Diaphragms 12 and 14 are both configured to move back and forth along a common axis 31, as indicated by the arrowheads on the axis.

In this example the first and second voice coils are located at different distances from the common axis. This allows the voice coils to move past each other, so that the two diaphragms can be closer together than they would be with two separate transducers arranged one on top of the other. In this example the first and second diaphragms are round and both centered on common axis 31, and the first and second voice coils are annular and are located at different radii from the common axis. In an example the voice coils are designed such that both reach their limits of motion at the same voltage. In an example both coils have the same resistance, motor constant, and mass. When the coils are matched they can be driven with a common audio signal, which simplifies the electronics.

In an example the use of bobbins to carry the coils helps to maximize overall performance and allow both sides to be magnetically matched. Without the bobbin, the coil axial length must be long enough to offset the cone (diaphragm) from the magnetics to avoid the cone bottoming on the magnetics. In some cases, the coil may need to be longer to achieve the proper bottoming clearance, which may degrade magnetic performance (e.g., increased moving mass) and also cause one side to be much different from the other. In other words, in some examples the use of the bobbin decouples the geometric constraint on the coil length (cone bottoming) from the magnetic constraint (high magnetic performance and magnetic matching of the sides).

In an example the first and second diaphragms are controlled such that they move in opposition (i.e., they both move out and in at the same time). In an example the total mechanical moving mass of the first diaphragm and coil is approximately equal to that of the second diaphragm and coil. This creates a balanced transducer that minimizes vibrations that could be sensed by a microphone (not show) that is part of the acoustic device that includes transducer 10a.

Single common magnetic circuit 40a comprises a permanent magnet 42 with an outer extent 43 that is closer to the common axis than are both of the voice coils. For a round transducer magnet 42 is generally cylindrically shaped. The single common magnetic circuit further comprises a generally annular magnet 50 located farther from the common axis than are both of the voice coils. In an example the permanent magnet and the generally annular magnet are generally co-planar, but they need not be. In the illustrated example the single common magnetic circuit further comprises ferromagnetic plates 44 and 46 on opposed sides of the permanent magnet, one ferromagnetic plate between the permanent magnet and the first diaphragm and the other ferromagnetic plate between the permanent magnet and the second diaphragm. The single common magnetic circuit further comprises generally annular ferromagnetic plates 52 and 54 on opposed sides of the annular permanent magnet, one generally annular ferromagnetic plate between the generally annular magnet and the first diaphragm and the other generally annular ferromagnetic plate between the generally annular magnet and the second diaphragm. Support 48 is located between one ferromagnetic plate 44 and one generally annular ferromagnetic plate 54. One coil 32 is located between support 48 and permanent magnet 42 and the other coil 22 is located between support 48 and generally annular permanent magnet One magnetic circuit gap 57 is between ferromagnetic plate 46 and generally annular ferromagnetic plate 54, and the other magnetic circuit gap is between ferromagnetic plate 44 and generally annular ferromagnetic plate 52.

Magnets 42 and 50 are oppositely polarized so that the flux path runs through both magnetic circuit gaps. For example, the top face of magnet 42 (that is closest to diaphragm 12) is polarized as north while the top face of magnet 50 is polarized as south. Since members 44, 48, and 54 can in some cases create a potential magnetic short circuit, arranging the magnets with opposed poles results in members 44 and 54 both with the same polarization, thus there will be no short circuit. Member 48 can thus be steel, to provide greater structural integrity to the transducer.

Basket 60 supports diaphragm surrounds 24 and 34 and also includes openings (vents) 62 that allow for venting of air from behind the diaphragms. Audio transducer baskets are well known in the field and so are not further described herein.

Transducer 10b, FIG. 2, differs from transducer 10a in that transducer 10b includes unitary ferromagnetic yoke member 70 with one portion 72 on the face of permanent magnet 42 that is closest to diaphragm 12, a second portion 76 on the side of generally annular magnet 50 that is closest to diaphragm 14, and a connecting portion 74 that is located between both coils and connects portions 72 and 76. Yoke 70 effectively replaces plates 44 and 54 and connecting portion 48. Yoke 70 can be formed as a single piece, which can simplify assembly of the transducer.

Transducer 10c, FIG. 3, differs from transducer 10a in part in that there is no outer magnet 50 in transducer 10c. Instead, unitary ferromagnetic magnetic circuit member 80 accomplishes the part of the magnetic circuit that carries the magnetic flux between ferromagnetic plates 44 and 46 by including portion 82 that is effectively the same as plate 54, FIG. 1, and is aligned with plate 46, and portion 84 that replaces plate 52, FIG. 1.

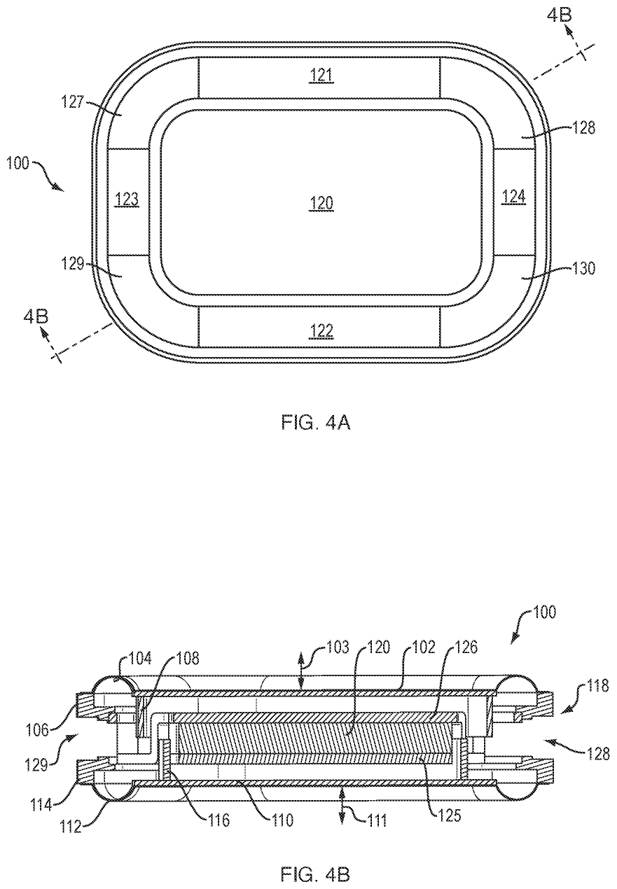

FIGS. 4A and 4B schematically illustrate generally rectangular transducer 100 that is of a type such as disclosed in U.S. Pat. No. 10,609,465, issued on Mar. 31, 2020, the entire disclosure of which is incorporated herein by reference for all purposes. Transducer 100 includes a generally rectangular first diaphragm 102 that moves up and down in the direction of arrow 103 and a generally rectangular second diaphragm that moves up and down in the direction of arrow 111. Diaphragm 102 carries coil 108 and is supported on basket 106 by surround 104. Diaphragm 110 carries coil 116 and is supported on basket 114 by surround 112. Magnetic circuit 118 includes generally rectangular magnet 120, ferromagnetic plate 125, and ferromagnetic yoke 126. Not visible in the figures are four side bar magnets, which are located in locations 121, 122, 123, and 124, FIG. 4A. The corners 127-130 are left open (i.e., there are no bar magnets in the corners), as illustrated in FIG. 4B, to provide a more open airflow path from the back of the diaphragms, around the respective voice coils, and out to the environment. Back side air flow can be further facilitated as needed by removing two of the side magnets on opposed sides so that magnetic forces are more balanced (e.g., the magnets at locations 121 and 122, or the magnets at locations 123 and 124).

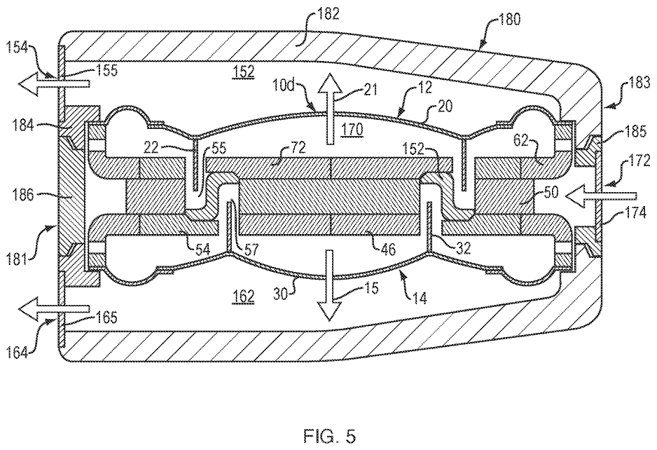

FIG. 5 discloses an exemplary wearable audio device 150 that includes a dual diaphragm transducer 10d with diaphragms 12 and 14 that move in opposition such that their front side sound pressure enters front cavities 152 and 162, respectively, and then exits to the environment through openings 154 and 164, respectively. In an example these openings are covered by a water-resistant screen 155 and 165, respectively, which provides environmental resistance. The rear side radiation from both diaphragms enters common cavity 170 and exits to the environment through opening 172 that is covered by screen 174. Screen 174 needs to be sufficiently open such that the driver is not damped.

Housing 180 includes outer housing member 182 with open end 181 that is partially closed by cap 184 and sleeve 186, to define openings 154 and 164. The front side sound pressure from both diaphragms exits through end 181. The opposite end 183 of housing 180 carries cap 185 that defines rear opening 172. Since the front side and rear side radiation is out of phase and exits from opposite ends of the housing, device 150 acts as an acoustic dipole. In some examples housing 180 is held or mounted on the ear, the head, or the upper torso with mechanical mounting elements, not shown. End 181 is located closer to the ear than end 183 and such that the front side radiation from openings 154 and 164 will at least in part reach the ear before it is cancelled by the rear side radiation from opening 172. A result is a low spillage wearable audio device. Since the volume displacement from each diaphragm is combined, the bass output doubles as compared to a single diaphragm transducer. However, the total height of the dual-diaphragm driver increases by only about 40% as compared to a single diaphragm driver. Also, the motions of the diaphragms are opposed, so the force imposed on the housing is balanced, which reduces vibrations. This can reduce undesirable feedback instability in products with microphones for hearing assistance or ANR.

FIG. 5 also illustrates an alternative ferromagnetic or non-ferromagnetic “Z”-shaped yoke member 152 that is located such that it spans both magnetic circuit gaps 55 and 57. Yoke 152 supports plate 72 (and thus also magnet 42 and plate 46) on annular plate 54. Yoke 152 is located in part outside of the innermost coil 32.

Other configurations of the wearable audio device are also contemplated and within the scope of this disclosure. Different and/or additional vents and screens can be used in either end of the housing or in other opposed portions of the housing. Different combinations of vents and screens are described in U.S. patent application Ser. No. 16/558,239, filed on Sep. 2, 2019, the entire disclosure of which is incorporated herein by reference for all purposes. Also, the front sides could vent into a common waveguide/port that is ducted closer to the ear, as disclosed in U.S. patent application Ser. No. 16/553,751, filed on Aug. 28, 2019, the entire disclosure of which is incorporated herein by reference for all purposes.

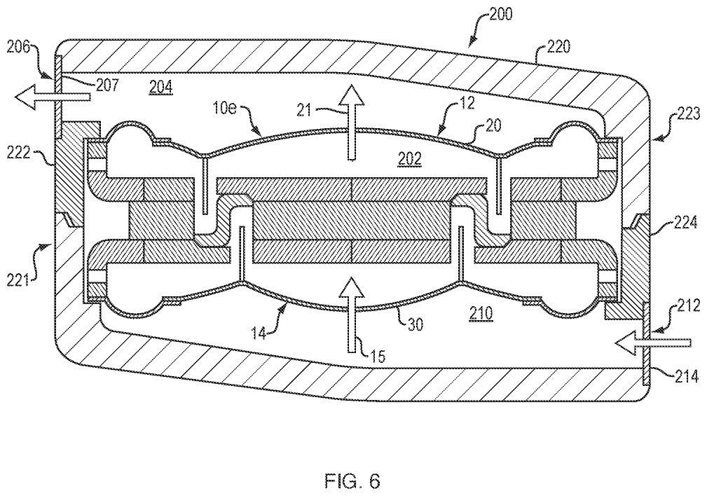

FIG. 6 discloses an exemplary wearable audio device 200 that includes a dual diaphragm transducer 10e with diaphragms 12 and 14 that move in parallel as indicated by arrows 21 and 15. The front side sound pressure from diaphragm 12 enters front cavity 204 and then exits to the environment through opening 206 covered by screen 207. The front side radiation from diaphragm 14 enters front cavity 210 and then exits to the environment through opening 212 covered by screen 214. The fronts of the diaphragms can be made waterproof. The common back cavity 202 is sealed, which protects the coil, lead-outs and motor from the environment. Device 200 can thus be made waterproof.

Housing 220 has end 221 that is partially closed by cap 222, to define opening 206. The opposite end 223 of housing 220 is partially closed by cap 224, to define opening 212. Since the sound in cavities 204 and 210 is out of phase and exits from opposite ends of the housing, device 200 acts as an acoustic dipole. In some examples housing 220 is held or mounted on the ear, the head, or the upper torso with mechanical mounting elements, not shown, with one end located closer to the ear than the other end such that the front side radiation from the opening closest to the ear will at least in part reach the ear before it is cancelled by the front side radiation from the other opening. A result is a low spillage, waterproof, wearable audio device.

A number of implementations have been described. Nevertheless, it will be understood that additional modifications may be made without departing from the scope of the inventive concepts described herein, and, accordingly, other examples are within the scope of the following claims.

What is claimed is:

1. An electroacoustic transducer, comprising:
a first diaphragm;
a first voice coil that is directly or indirectly coupled to the first diaphragm;
a second diaphragm;
a second voice coil that is directly or indirectly coupled to the second diaphragm; and
a single common magnetic circuit that is configured to provide a magnetic field in both a first magnetic circuit gap and a separate second magnetic circuit gap;
wherein the first voice coil is located at least in part in the first magnetic circuit gap and the second voice coil is located at least in part in the second magnetic circuit gap.

2. The electroacoustic transducer of claim 1 wherein the first and second diaphragms are both configured to move back and forth along a common axis.

3. The electroacoustic transducer of claim 2 wherein the first and second voice coils are located at different distances from the common axis.

4. The electroacoustic transducer of claim 3 wherein the first and second diaphragms are round and both centered on the common axis, and wherein the first and second voice coils are annular and are located at different radii from the common axis.

5. The electroacoustic transducer of claim 2 wherein the single common magnetic circuit comprises a permanent magnet with an outer extent that is closer to the common axis than are both of the voice coils.

6. The electroacoustic transducer of claim 5 wherein the single common magnetic circuit further comprises a generally annular magnet located farther from the common axis than are both of the voice coils.

7. The electroacoustic transducer of claim 6 wherein the permanent magnet and the generally annular magnet are generally co-planar.

8. The electroacoustic transducer of claim 6 wherein the single common magnetic circuit further comprises ferromagnetic plates on two sides of the permanent magnet, one ferromagnetic plate between the permanent magnet and the first diaphragm and the other ferromagnetic plate between the permanent magnet and the second diaphragm.

9. The electroacoustic transducer of claim 8 wherein the single common magnetic circuit further comprises generally annular ferromagnetic plates on two sides of the annular permanent magnet, one generally annular ferromagnetic plate between the generally annular magnet and the first diaphragm and the other generally annular ferromagnetic plate between the generally annular magnet and the second diaphragm.

10. The electroacoustic transducer of claim 9 further comprising a support between one ferromagnetic plate and one generally annular ferromagnetic plate.

11. The electroacoustic transducer of claim 10 wherein one coil is located between the support and the permanent magnet and the other coil is located between the support and the generally annular permanent magnet.

12. The electroacoustic transducer of claim 9 wherein the first magnetic circuit gap is between a first ferromagnetic plate and a first generally annular ferromagnetic plate and the second magnetic circuit gap is between a second ferromagnetic plate and a second generally annular ferromagnetic plate.

13. The electroacoustic transducer of claim 6 wherein the single common magnetic circuit further comprises a ferromagnetic plate on a first side of the permanent magnet between the permanent magnet and the first diaphragm, a generally annular ferromagnetic plate on a second side of the generally annular magnet between the generally annular magnet and the second diaphragm, and a ferromagnetic yoke member comprising a first portion on the second side of the permanent magnet, a second portion on the first side of the generally annular magnet, and a connecting portion located between both coils that connects the first and second portions.

14. The electroacoustic transducer of claim 5 wherein the single common magnetic circuit further comprises ferromagnetic plates on two sides of the permanent magnet, a first ferromagnetic plate between the permanent magnet and the first diaphragm and a second ferromagnetic plate between the permanent magnet and the second diaphragm, and a ferromagnetic yoke member located at least in part outside of the first coil, wherein the yoke member comprises a first portion spaced from the first ferromagnetic plate, a second portion spaced from the second ferromagnetic plate, and a connecting portion that connects the first and second portions.

15. The electroacoustic transducer of claim 2 wherein the first and second diaphragms are configured to move in opposition.

16. The electroacoustic transducer of claim 15 wherein a total mechanical moving mass of the first diaphragm and coil is approximately equal to that of the second diaphragm and coil.

17. The electroacoustic transducer of claim 1 wherein the first and second diaphragms are generally rectangular.

18. The electroacoustic transducer of claim 1 wherein the first and second diaphragms, the first and second coils, and the magnetic circuit are contained in a housing that defines at least one sound-emitting opening.

19. The electroacoustic transducer of claim 18 wherein the first and second diaphragms each generate front side acoustic radiation from a front side thereof, and wherein the housing further defines a first front acoustic cavity that is configured to receive the front side acoustic radiation from the first diaphragm and a second front acoustic cavity that is configured to receive the front side acoustic radiation from the second diaphragm.

20. The electroacoustic transducer of claim 19 wherein the housing defines a first sound-emitting opening that is configured to emit sound from the first front acoustic cavity into an external environment and a second sound-emitting opening that is configured to emit sound from the second front acoustic cavity into the external environment.

21. The electroacoustic transducer of claim 20 wherein the housing further defines a common rear acoustic cavity that is configured to receive rear side acoustic radiation from both the first and second diaphragms, and a third sound-emitting opening that is configured to emit sound from the rear acoustic cavity into the environment.

22. The electroacoustic transducer of claim 21 wherein the housing defines two opposed ends, and wherein the first and second sound-emitting openings are in one end of the housing and the third sound-emitting opening is in the other end of the housing.

23. The electroacoustic transducer of claim 20 wherein the housing defines two opposed ends, and wherein the first sound-emitting opening is in one end of the housing and the second sound-emitting opening is in the other end of the housing.

24. The electroacoustic transducer of claim 23 wherein the first and second diaphragms are configured to move in parallel.

25. The electroacoustic transducer of claim 1, wherein the first voice coil is indirectly coupled to the first diaphragm by a first bobbin, and the second voice coil is indirectly coupled to the second diaphragm by a second bobbin.
